(19) United States
(12) Patent Application Publication
(10) Pub. No.: US 2020/0159321 A1
(43) Pub. Date: May 21, 2020

(54) COMMUNICATION USING BIOPOTENTIAL SENSING AND TACTILE ACTIONS

(71) Applicant: Pison Technology, Inc., Brookline, MA (US)

(72) Inventors: Dexter W. Ang, Brookline, MA (US); David O Cipoletta, Chepachet, RI (US); Samuel J. Karnes, Narragansett, RI (US); Salil H. Patel, Houston, TX (US)

(73) Assignee: Pison Technology, Inc., Brookline, MA (US)

(21) Appl. No.: 16/196,462

(22) Filed: Nov. 20, 2018

(51) Int. Cl. G06F 3/01; G08B 6/00

(52) U.S. Cl. CPC G06F 3/015; G06F 3/014; G08B 6/00; G06F 3/016

(57) ABSTRACT

Among other things, a received inbound message is presented to a person wearing a wearable device. The inbound message is presented to the person as tactile stimulation of skin of the person. Monitoring is done for presence of an outbound message derived from biopotential signals sensed at the skin of the person after the receipt of the inbound message.

### BACKGROUND

This description relates to communication using biopotential sensing and tactile actions.

In situations in which personal communication by typical speech or body gestures is not possible or not convenient or not appropriate, other approaches can be used such as electronic communication through computers or mobile devices. Use of computers and mobile devices usually requires a user to speak and listen or to manipulate keyboards or mouse devices to control, enter, and read information presented in user interfaces. When a person's ability to speak and move his fingers or hands is compromised or when his use of speech and visible motions would be inappropriate, inconvenient, or undesirable, communication can become difficult or impossible.

As the condition of ALS patients declines, for example, they become less able to activate muscles to speak or to gesture with their fingers and hands. Eventually they cannot speak and can only perform (if at all) slight gestures or motions making communication with others, including their caregivers, difficult and eventually almost impossible.

Caregivers must be in nearly continual physical proximity to ALS patients to remain aware of and assess their condition and needs and to provide care and assistance. In addition to other tasks, caregivers must periodically monitor or operate special equipment for ALS patients.

Such uninterrupted close-proximity caregiving is stressful to the caregiver and detrimental to the independence and privacy of the patient causing the quality of life (QOL) of both the patient and the caregiver to suffer.

In earlier stages of ALS, patients may be able to use typical mobile devices and computers for communication. In later stages, when these devices are no longer usable, some aspects of the patients' quality of life, such as connections with caregivers and family members, still can be preserved using simple communication tools like sign-language, letter boards for spelling, symbol and picture boards, erasable note boards, bells, and intercoms. Intercoms and monitoring devices require cognitive attention and physical manipulation limiting their usefulness. Specialized high-technology tools (e.g., speech generators, voice output communication aids, head-mouse systems, and brain-computer interfaces) may also be used. Eye-trackers, for example, respond to patient eye movements (which are among the last-affected in ALS) to move cursors on a computer screen. For simple communications, personal pagers and alert systems can notify caregivers not in close proximity to ALS patients of the patients' need for attention. However, eventually ALS patients can lose the ability to use such high-technology tools and find it difficult even to push a button of a transmitter of a personal pager or alert system.

Similar considerations apply to patients with a variety of neuromuscular and other disorders (e.g., myasthenia gravis, Guillain-Barré syndrome, and poliomyelitis; and disorders of consciousness) and their caregivers.

### SUMMARY

In general, in an aspect, a received inbound message is presented to a person wearing a wearable device. The inbound message is presented to the person as tactile stimulation of skin of the person. Monitoring is done for presence of an outbound message derived from biopotential signals sensed at the skin of the person after the receipt of the inbound message.

Implementations may include one or a combination of two or more of the following features. The inbound message includes a status request. The status request includes a poll. The presenting of the inbound message includes vibrating the skin of the person. The inbound message these decoded as a profile of tactile stimulation of skin. The presenting includes presenting the profile of tactile stimulation. The presence of an outbound message within a predetermined response period after the receipt of the inbound message serves as a reply to the inbound message. The lack of presence of an outbound message within a predetermined response period after the receipt of the inbound message serves as a reply to the inbound message. The monitoring for presence of an outbound message derived from biopotential signals includes sensing biopotential signals indicative of an intention by the person wearing the wearable device to reply to the inbound message. The sensed biopotential signals are encoded as the outbound message. The outbound message is sent to another participant. The biopotential signals are sensed at the wearable device. The wearable device is situated at a wrist of the person. The receiving of the inbound message includes receiving the inbound message wirelessly from another device. A series of inbound messages are received at the wearable device. The inbound messages include polls.

In general, in an aspect, an inbound message is is sent to be presented as tactile stimulation of skin of a person wearing a wearable device, and presence of an outbound message derived from biopotential signals sensed at the skin of the person is monitored after the sending of the inbound message.

Implementations may include one or a combination of two or more of the following features. The inbound message includes a status request. The status request includes a poll. The presence of an outbound message within a predetermined response period after the sending of the inbound message is interpreted as a reply to the inbound message. The lack of presence of an outbound message within a predetermined response period after the sending of the inbound message is interpreted as a reply to the inbound message. The sending of the outbound message includes sending the inbound message wirelessly from another device. The series of output messages includes polls. Characteristics of wireless communication signals (such as Bluetooth signal strength) used by one or more of the wearable devices and one or more of the electronic devices (e.g., a wireless device worn or carried by a caregiver) can be used to infer and record the distance between them.

In general, in an aspect, a wearable device includes a support configured to hold a wearable device on a body part of a user, a wireless transmitter, a wireless receiver, a tactile element configured to be in contact with skin of a user, a biopotential sensor configured to be in contact with skin of the user, storage for executable instructions, and a processor. The processor is to execute the instructions to cause: (a) the wireless receiver to receive an inbound message, (b) the tactile element to convey the inbound message to the user through the skin of the user, (c) the biopotential sensor to sense biopotential signals at the skin of the user within a predetermined amount of time after the inbound messages conveyed to the user through the skin of the user, and (d) the transmitter to send an outbound message including the biopotential signals or biopotential information derived from the biopotential signals.

These and other aspects, features, implementations, and advantages (a) can be expressed as methods, apparatus, systems, components, program products, business methods, means or steps for performing functions, and in other ways, and (b) will become apparent from the following description and from the claims.

### DESCRIPTION

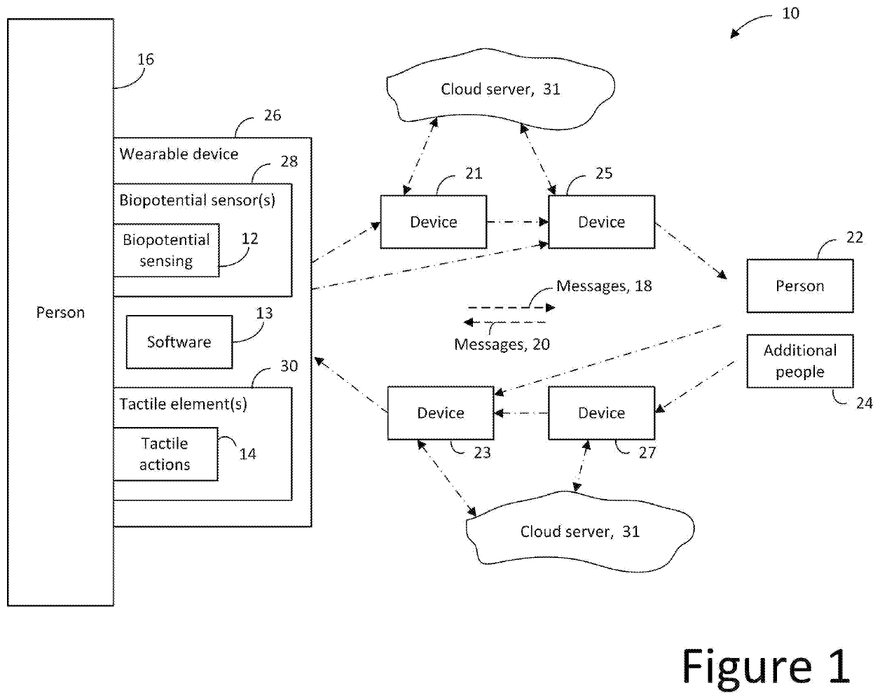

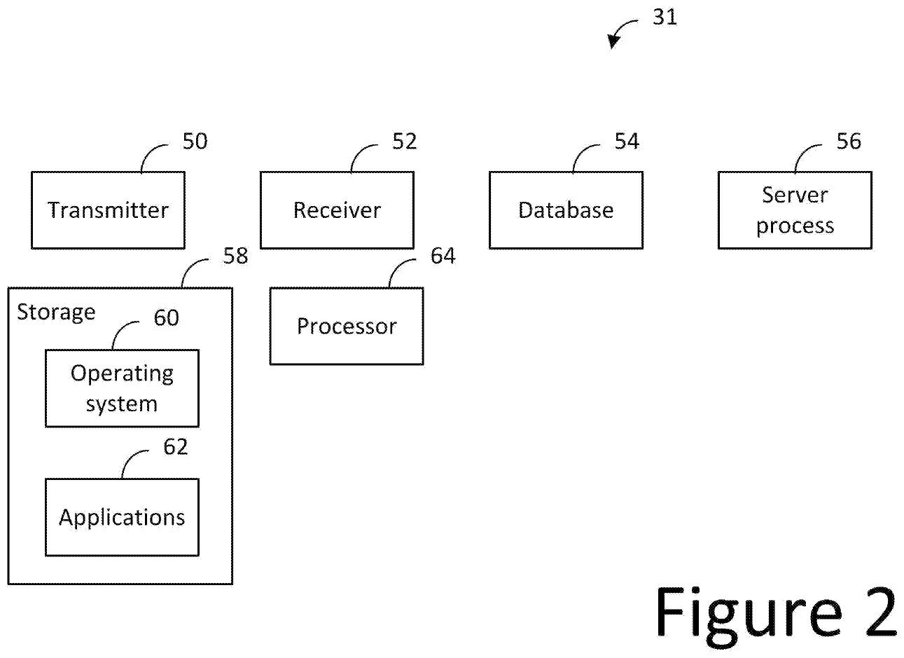

FIGS. 1 and 2 are block diagrams.

### DEVICES

As shown in FIG. 1, a communication technology 10 (the “technology”) can apply biopotential sensing 12 and tactile actions 14 to enable a person 16 to communicate by sending messages 18 to and receiving messages 20 from one or more other people 22, 24 or in some cases to or from an electronic device 21, 23, 25, 27. The technology enables the communication (sending or receiving messages or both) even though the person 16 is constrained in his ability to use muscles of his body, for example, to speak, move his eyes, move a finger or hand or other body part, or to gesture. Under such a constraint, the person cannot engage in normal speaking and gesturing communication with other people or electronic devices, directly or through user interfaces. In some cases, the biopotential sensing and the tactile actions are implemented together on a wearable device 26, for example a device worn around a wrist (or other limb) of the person 16. In some instances, the biopotential sensing and the tactile actions can be implemented in separate devices that interact with the skin of the person.

In some implementations, the wearable device 26 can send its biopotential information directly to a device 25 that is in the vicinity of the participant person. For example, the constrained person could be in one room of the house in the participant person could be in a nearby room. Then the wearable device could communicate wirelessly through a short-range network directly with the device 25 to provide the message to the participant person.

Although we frequently use digital devices as examples of the electronic devices 21, 23, 25, and 27, the technology may also take advantage of analog devices and of digital devices that are integrated with analog components. The analog devices or analog components can include, for example, joysticks, pointing sticks, pedals, 3D mice, foot pedals, pneumatic switches, breathing-activated switches, and dials.

### Contexts of Use

The constraint on the person's use of muscles may be caused by a medical condition such as ALS or by a context in which visible or audible use of muscles—although physically possible—is inappropriate, undesirable, or unwanted. An example of such a context could be a meeting in which the person may wish to send a message to someone outside the meeting room without anyone in the meeting being aware of the communication. The technology can enable communication that would otherwise not be appropriate, desirable, or wanted. In the case of ALS, the technology can improve the quality of life for both patients and caregivers. The technology also has a wide range of applications to other people, fields, and contexts.

In some implementations of the technology, one or more of the electronic devices, such as the electronic device 21, can be situated near the constrained person. For example, the electronic device 21 could be a cellular telephone, a laptop computer, a tablet, or another kind of wireless-capable device located in the same room or other space as the constrained person or within a range provided by a short-range wireless channel or network. Similarly, if the other participant is one of the people 22, 24, the electronic device 25 can be situated nearby. For example, the electronic device 25 could be a cellular telephone, a laptop computer, a tablet, a voice assistant or another kind of wireless-capable device located in the same room or other space as the other person or within a range provided by a short-range wireless channel or network. The electronic device 25 could be a wearable device similar to the wearable device 26.

Each of the wearable device also can include memory and one or more processors, a wireless transmitter and receiver, and a user interface (among other components). These components enable the wearable device to interpret the biopotential signals as biopotential information, store the biopotential information, send the biopotential information to other devices, present the biopotential information and other information to a user, receive input from the user, and perform other tasks.

### Definitions

We use the term “communication” broadly to include, for example, any initiation or sending of a message to a person or device or the receiving or processing of a message from a person or a device. Communication can include single occurrences or successive iterations of initiating or sending or receiving or processing or both. A communication can be of any kind, include any information, occur at any time and place, and have any purpose.

We use the term “message” broadly to include, for example, any text, number, image, video, signal, token, code, sign, indicia, report, command, response, acknowledgement, request, alert, query, poll, comment, reply, or answer, for example. A message can include silence or a failure to respond and can be at least partially meaningless, ambiguous, garbled, or incorrect.

The technology can be applied to make communication simpler, easier, faster, and more effective, and in some situations, make possible communication that would otherwise be difficult, inappropriate, inconvenient, undesirable, or impossible. As shown in FIG. 1, in some applications of the technology 10, the communication (e.g., sending and receiving messages 18, 20) is between what we call a “constrained person” 16 and one or more other people 22, 24 or one or more devices, such as devices 21, 23, 25, 27. We sometimes call the other person (or people) or the other device an “other participant” in the communication.

We use the term “constrained person” broadly to include, for example, any person for whom using muscles to send or receive messages or otherwise engage in communication in a normal way (a) is physically impossible or more difficult than for a normal person, (b) occurs in a context in which sending or receiving messages is one or more of inappropriate, undesirable, inconvenient, or unwanted, or (c) a combination of (a) and (b).

### Implementing an Intent to Communicate

As shown in FIG. 1, using the technology 10, a person 16 (such as a constrained person) who has an intention to communicate with (e.g., send messages 18 to or receive messages 20 from or both) one or more other people 22, 24 or devices (the other participant) can send messages by acting on his intention to do so. The person can implement the intention by doing one or more of the following: (a) activating or attempting to activate a muscle (even if the muscle is not actually activated or is activated to a limited degree), (b) causing a finger, hand, or other part or parts of his body to move as a result of the activation or the attempt to activate one or more muscles, or (c) gesturing by causing the motion of a part or parts of the body. When the person activates or attempts to activate a muscle, biopotentials occur in related parts of the body.

### Biopotential Sensing

The wearable device can include one or more biopotential sensors 28 configured to sense the biopotential signals (e.g., voltages) at the skin of the person (e.g., the skin on the upper surface of the wrist or the forearm adjacent the wrist).

Additional information about (a) skin-surface biopotential sensors, techniques for interpreting biopotential signals as intended muscle activations, actual muscle activations, motions and micromotions (e.g., very small or brief motions) of body parts, and gestures, (b) uses of the biopotential signals in user interface devices and to control electronic devices, and (c) wearable devices that sense, interpret, use, and communicate biopotential signals and biopotential information can be found in U.S. Pat. No. 10,070,799, issued on Sep. 11, 2018, U.S. patent application Ser. No. 16,055,123, filed on Aug. 5, 2018, U.S. patent application Ser. Nos. 16/055,777, 16/055,859, and 16/055,991, filed on Aug. 6, 2018, and U.S. patent application Ser. No. 16,104,273, filed on Aug. 17, 2018, all of which are incorporated here by reference.

### Biopotential Information

The biopotential signals that result when a person activates or attempts to activate a muscle in the vicinity of the biopotential sensors can be sensed and processed at the wearable device to generate, for example, biopotential information. The biopotential information can include elements representing (a) one or more intentions of the person expressed by signals from the brain directed through nerves to one or more muscles, (b) identifications of the muscle or muscles (if any) activated as a result of the expressed intentions, (c) identification of the part or parts of the body moved by the corresponding activations of the muscles, (d) identification of one or more gestures corresponding to the motion of the body part or parts, or (e) combinations of them.

### Encoding Biopotential Information as Outbound Messages

The human body is characterized by its large number, wide variety, and diverse locations of muscles and the ability of a person to use her intentions to cause the brain to activate each of the muscles and combinations of them across a spectrum from subtle tiny micro-motions to coarse intense activations. The resulting profusion of intentions, activations, motions, and gestures and combinations of them that are possible at a given time and during a succession of times can serve as tokens in a vocabulary of biopotential information. Combinations of these tokens can be used by a constrained person according to such a code to express outbound messages in ranges from simple, brief, and direct to complex, long, and nuanced. For example, the constrained person could extend an index finger for about one second and then extend a middle finger for about two seconds as tokens to represent a message “Please open the door. And let the cat in.” Tokens of the biopotential information vocabulary can be based, for example, on characteristics of the constrained person's intentions, activations, motions, and gestures, for example: type, location, pattern of locations, intensity, duration, spacing over time, and combinations of them.

### Outbound Messages

One or more elements of the biopotential information can constitute or be used to form one or more messages from the constrained person to another participant. We sometimes refer to messages from the constrained person as “outbound messages”. For example, a finger flick can be incorporated in an outbound message to an electronic device indicating that the constrained person does not need help. In some cases, the biopotential information can be encoded in an outbound message in a format or according to a protocol that can be understood by another participant. We sometimes use the term “biopotential information” to include such an outbound message, and we sometimes use the term “outbound message” to include such biopotential information. The encoding of the biopotential information as an outbound message can be done at the wearable device, at another device along a chain of message carriers, by another participant, or by a combination of them.

### Tactile Actions and Inbound Messages

The technology also provides for messages directed to the constrained person. We sometimes call them “inbound messages.” In some implementations of the invention, inbound messages can be decoded or interpreted as a combination of one or more tactile actions to be applied on or at skin of the constrained person, for example, skin on or in the vicinity of the wrist. We use the term “tactile actions” broadly to include, for example, any activity or state that can be sensed at or by the skin, such as, for example, vibration, strokes, pokes, punctures, adhesion, heat, cooling, humidity, electricity, pressure, and others, or combinations of them. In some examples, the wearable device can include one or more tactile action elements 30 configured to effect tactile actions on or at the surface of the skin of the person. A variety of tactile elements could be used, for example, haptic elements to cause vibrations, electrical elements to cause small electrical currents, thermal elements to cause elevated or reduced temperatures, and others, and combinations of two or more of them.

In some implementations, tactile actions encoded in the inbound messages can be combined with other categories of actions for a variety of purposes. The other categories of actions could include light, sound, images, or videos presented on the user interfaces of the wearable device or one or more other devices in conjunction with the presentation of the tactile actions. For example, when an inbound message is a polling message (see discussion below) that causes a haptic vibration against the skin of a constrained person, the haptic vibration could be accompanied by a light blinking or flashing on the wearable device or on another electronic device in the vicinity of the constrained person. The blinking a flashing light would reinforce the presence of the polling message. In some cases, if the constrained person did not send an outbound message responding to the inbound polling message, the flashing light could grow brighter or change color, for example, to attempt to trigger the constrained person to send an outbound message. If the cloud server or the nearby electronic device did not receive an outbound message within a predetermined amount of time, the cloud server or the nearby electronic device could cause the light to grow brighter or change color. Eventually, if no outbound message is received, the cloud server could alert another participant (e.g., a caregiver) that the constrained person is not responded to a polling message despite simultaneous multimodal attempts to provoke a responding outbound message.

### Decoding Tactile Actions from Inbound Messages

The combination of tactile actions that are decoded from the inbound messages can be one or more tactile actions to be applied at one time or one or more tactile actions to be applied in one or more combinations over time. A large number and great variety of combinations of tactile actions to be applied to the skin can be expressed in (and then decoded from) inbound messages ranging from simple to complex. The available combinations of tactile actions can serve as tokens in a vocabulary of tactile actions. A wide variety of different inbound messages and parts of inbound messages can be expressed to enable decoding to obtain the tokens of the vocabulary.

Tokens of the tactile actions vocabulary can be based, for example, on characteristics of tactile actions as applied to the skin, for example: type, intensity, duration, spacing over time, location on the skin, or patterns of locations on the skin and combinations of two or more of those at a given time or at successive times. For example, an inbound message asking the constrained person to reply with the time when he wants dinner and the extent of his appetite could be decoded to one token to cause a one-second weak vibration of the skin (meaning “tell me the time when you want dinner”) followed by another token to cause three quick intense vibrations (meaning “tell me how hungry you are”).

### Chain of Message Carriers

Messages from a constrained person to another participant can be passed through a chain of one or more message carriers from the constrained person to the other participant or participants. As shown in FIG. 1, the message carriers in the chain can include one or more electronic devices 21, 25 (including electronic devices not shown) and a cloud server 31, among others. The chain of message carriers for a given message can include one or more message carriers and can end at the other participant, which can be one of the electronic devices or one of the people 22, 24.

Typically the electronic devices and cloud server in chains of message carriers will communicate with one another wirelessly (e.g., through a short-range wireless network such as Wi-Fi or through a long-range cellular network) although it is possible that two or more of the devices could be interconnected by wire.

### Two Way Messages and Communications

The ability to create and send outbound messages using a robust vocabulary of biopotential information vocabulary and to receive, translate, and present inbound messages by applying a decoding a rich vocabulary of tactile action tokens provides a powerful two-way medium for communication between the constrained person and another participant. The communication modes using this two-way medium can range from simple to complex.

Back-and-forth communication between a constrained person and a participant device or participant person can be conducted by the constrained person (a) for an outbound message, sending brain signals indicating an intent to activate a muscle, activating a muscle, moving a part of the body by activation of the muscle (including speaking), and using the motion of body parts as gestures, and combinations of them, and (b) for an inbound message sensing and interpreting tactile actions of the tactile elements applied based on decoded tokens of the inbound message.

### Outbound Messages

To send an outbound message, the constrained person selects and applies tokens of the biopotential information vocabulary corresponding to his intended content for the message. The tokens can include a set of one or more of the following actions at one time or a succession of times: activations or intended activations of muscles, motion of part or parts of the body, or gestures in accordance with the code for outbound messages. A representation of the outbound message then is sent to an electronic device that is part of a chain of one or more message carriers extending from the constrained person to the other participant. The outbound message can be expressed in different degrees of abstraction from concrete to abstract as it passes through the chain of message carriers. In a concrete form the outbound message can be expressed as the originally sensed raw biopotential signals. In an abstract form the outbound message can be expressed in a natural language or similar style. In other forms, the outbound message can be expressed as biopotential information of various kinds. Encoding of the sensed raw biopotential signals as elements of an outbound message can be done at one or more of the message carrier devices along the chain from the wearable device to the electronic device that ultimately presents the outbound message. At the end of the chain the outbound message is presented to the other participant (a person or an electronic device). For example, the other participant could be a caregiver, the biopotential signals generated at the skin of an ALS patient could indicate an intention to flick an index finger, the biopotential signals could be encoded in an outbound message, decoded at a cell phone of the caregiver and spoken as “I need help.” In some cases, the outbound message can be encoded in Morse code by a user signaling successive characters using the Morse code.

To send the outbound message through the chain, the wearable device can maintain a connection (e.g., a short-range wireless connection) to the electronic device in the chain using Bluetooth low energy technology or another short-range wireless technology.

### Inbound Messages

An inbound message can have any content, length, style, type, or purpose and can be configured by another participant (a person or an electronic device) to provide information, give a command, ask a question, answer a question, or serve any other purpose. A representation of the inbound message is sent through a chain of message carriers to the constrained person. When the inbound message reaches the constrained person it is presented as tokens of a tactile action vocabulary, for example, by vibrating the skin three times with successively stronger vibrations.

The inbound message can be expressed in different levels of abstraction from concrete to abstraction as it passes through the chain of message carriers. In an abstract form the inbound message can be expressed in natural language or a similar style. In a concrete form the inbound message can be expressed as tokens of the tactile action vocabulary. In some examples the inbound messages could be expressed in Morse code or a similar code. Other forms are also possible. Translation of the abstract form to the concrete form can be done in one or more stages at one or more of the message carrier devices along the chain from the other participant to the wearable device of the constrained person.

The delivery of inbound messages 20 from other participant people or devices to the constrained person can proceed in a variety of ways depending upon the application. The first step in the communication of a message (when the participant is a person) can be for the other participant to express the message through the device 27. For this purpose, the device 27 could be a wearable device as described above, and the expression of the message by the person could be represented by an intent to move a muscle, a motion of a muscle, or gesture, among other things. In some cases, the device could be a cell phone, tablet, a laptop, the camera, a microphone, voice assistant, or another device capable of sensing, receiving, or interpreting the expression of the message by the participant person. For example, the other participant person could speak a message to a cell phone or could touch a touch-sensitive surface of the device.

Once the message has reached the device 23, it can communicate the message wirelessly (e.g., at short-range) to the wearable device. The wearable device then can use the message to control the tactile elements to convey the message by causing skin sensations on the skin of the constrained person.

### Presentation of Outbound Messages

In some implementations, the electronic device 25 that is worn by, used by, or near to each of the people 22, 24 who are other participants in the communication can include components configured to provide a variety of functions. For example, the electronic device 25 can receive, decode, interpret, and store incoming messages. Messages or interpretations or translations of them can be presented to the other participants through user interface features in a variety of ways, including by sound, light, speech, text, image, video, tactile action, or in other modes, or combinations of them. For example, a message that an ALS patient needs help could be presented as a flashing light or a beeping alarm. The presentation modes can depend on the capabilities of the device 25, which could be, for example, a cell phone, a laptop, a tablet, a voice assistant, or other electronic device. In some cases, the device 25 could be a wearable device worn by the other participant and configured to include one or more tactile elements or one or more biopotential sensors or both, similarly to the wearable device worn by the constrained person.

### Role of the Cloud Server

In some implementations, the cloud server 31 can communicate directly or indirectly with any electronic devices or wearable devices that are part of any chain of message carriers or otherwise part of the technology. The cloud server can provide other services in the creation, interpretation, delivery, management, and other processing of messages and communications. The cloud server also could perform other functions such as maintaining user accounts and profiles, storing control files and preferences expressed by or for the constrained person or another participant, and others. In some implementations, the cloud server can run on Microsoft Azure (a cloud computing platform) that supports HIPAA compliant operations to safeguard personal health information. Messages sent from the electronic devices to the cloud server can use the HTTP protocol rather than using Firebase cloud messaging and a local TCP socket.

### Cloud Server Components

As shown in FIG. 2, the cloud server 31 can include a transmitter 50 and a receiver 52 for communicating over a wireless communication channel with large number of wearable devices and other electronic devices including those shown in FIG. 1. The cloud server also can include a database 54, a web or application server process 56, storage 58 for an operating system 60 and applications 62, and one or more processors 64 configured to execute the operating system and the applications. The applications can include features to manage user profiles, to interact with mobile apps, process inbound messages and outbound messages, to maintain logs of activity, and a wide variety of other functions.

### Wearable Device Software

As shown in FIG. 1, software 13 executed by a processor on the wearable device provides functions associated with the technology. Some of these functions will be apparent from information set forth in the patent documents cited earlier. In addition, the software can cause the tactile elements to perform tactile actions in accordance with inbound messages, use the biopotential sensors to sense biopotential signals from the skin of the user, encode the biopotential signals or corresponding biopotential information in outbound messages, execute timers to determine whether biopotential signals have occurred within a predetermined period after the tactile actions have been applied to the skin of the user, and a wide variety of other functions.

### Applications

The technology supports a wide variety of applications enabling constrained users to communicate messages to and from participant people and devices. In some applications, the technology is useful for patients suffering from ALS and other similar debilitating illnesses.

### Polling

One technique for applying the technology to such patients uses inbound messages and outbound messages to implement a polling technique as a way to determine a state or condition of the constrained person.

We use the term “poll” or “polling” broadly to include, for example, any message, requests, inquiry, status check, or other communication directed to a device, process, or a person to obtain information, confirmation, or a response. The term “poll” can include the process of directing such communication or the content of the communication or both. In some cases, a poll is sent periodically or repeatedly.

In some implementations, a wearable device having tactile action elements and biopotential sensors can receive inbound polls (polling messages) periodically and automatically (such as hourly) from the cloud server. Each inbound message is a query having the meaning: “Is everything alright?”. The meaning can be encoded as a tactile action of a single one-second vibration. The patient can be taught that such a single one-second vibration corresponds to that query and to respond promptly to the poll by a single micro-motion of her finger or an attempt to make such as micro-motion. The micro-motion is sensed by the biopotential sensors and is encoded as an outbound message meaning “I'm alright,” sent by the wearable device through a chain of message carriers to the cloud server and to the cell phone of the caregiver, which buzzes, or speaks the message “At 8:43 p.m., your patient signaled that she is alright.” If no outbound message is received by the cloud server within a predetermined period after the delivery of the message to the skin of the patient (say, fifteen seconds), the cloud server infers that the patient needs attention and sends an outbound message to the caregiver's cell phone causing it to speak “Attention there was no response to the poll delivered at 8:42 p.m.”

Thus, in some cases, polling includes sending message in the form of simple status queries periodically from a participant device to the constrained person's wearable device and reporting to a caregiver or other attendant the responses to or lack of responses or other results of the queries. In some situations, such polling can relieve the caregiver of the need to be physically present in the vicinity of the patient or other constrained person. In some situations, different status queries can be presented to the constrained person by, for example, encoding them differently in the inbound messages. The different messages can use different tokens of the tactile action vocabulary to cause different sets of tactile actions, which can be interpreted by the patient, if the patient has been taught the vocabulary in advance.

For example, a status query “Is everything all right?” could be encoded as a long-duration vibration of a haptic element in the wearable device, and a different status query “Do you need suctioning?” could be encoded as a short-duration vibration. Similarly, the constrained person could use tokens of the biopotential information vocabulary in responsive outbound messages directed through the cloud server to an electronic device of the caregiver. For example, two successive micro-motions of a finger in an outbound message in response to an “Is everything alright?” query could represent the answer “yes” and three successive micro-motions of a finger in an outbound message in response to that query could represent the answer is “no”.

In some applications, a repeating timer could be provided by a mobile app running on a caregiver's smartphone during an active query period (say, 1-8 hours corresponding to the period when the caregiver is responsible for the patient) and at a given querying interval. At each timeout of the timer, an inbound message could be sent through the cloud server to the patient's wearable device to cause a tactile element to vibrate for a preselected period, such as 1-4 seconds. In some cases, the vibration representing the inbound message could be accompanied by a visual cue that would pop up within a window on the patient's phone, tablet, or computer informing the patient to send a reply message (for example the reply message described above) to the caregiver if she needs assistance. The patient can then respond with micro-movement of muscles that are sensed by the biopotential sensors of the wearable device and forwarded as an outbound message through a nearby electronic device to the cloud server and then to the electronic device near the caregiver. The caregiver can use a mobile app to control the frequency, timing, query period, and other parameters for the inbound polling messages to be sent automatically to the wearable device of the patient.

For communication with the electronic device near the caregiver, an application running on the cloud server can maintain a TCP port that can be written to or by the caregiver's phone, multiple caregivers' phones, or another connected mobile device, to cause the visual alert to pop up and tactile action messages to be delivered through the wearable device on the patient's wrist. The subsequent outbound notification messages can be sent to the caregiver app on the caregiver's phone using, for example, the Firebase cloud messaging platform, which provides reliable notifications to mobile devices. The smartphone app can run as a background service so that the caregiver can receive notification outbound messages from the cloud server while using other mobile apps.

The outbound notification messages received at the caregiver's phone can present sounds or visual cues to the caregiver through the phone or smart speaker, for example. Any repeated lack of patient reply message can also be used at the cloud server to cue an emergency alert message through the caregiver's phone to the caregiver.

In some implementations, the technology can monitor and store information about polling including, for example, the times when polls were sent, the devices to which the polls were sent, the content of the polls, the times when responses to the polls were received, the times when responses to the polls were not received, and the content of the responses to the polls. Analysis of the stored information can determine, for example, the effectiveness of various kinds of content contained in the polls, the effectiveness of various timings of the polls, the kinds of content returned in the responses to the polls, the kinds of devices with respect to which the polls are effective, the kinds of tactile actions that are effective, comfortable, or usable as part of polls. Experimentation can be done by changing the frequencies, timing, content, and target devices of polls to determine which polling regimes are most effective, comfortable, or usable.

### Location Data and Activation Data Usage

In some examples, a caregiver's cellphone can be paired with a patient's laptop, enabling detection, measurement, and storage of the caregiver's approximate location (e.g., in the local vicinity of the patient or father away) throughout the day. When a polling inbound message is received from the cloud server at the patient's laptop, the technology may measure and store the distance of the caregiver's cellphone (within approximately 20 feet) from the patient's laptop. The cloud server could then capture the patient's outbound response message and measure the caregiver's cellphone location (relative to the patient) after the outbound response message is received. This information can provide an objective measure of how caregiver location flexibility is affected by patient polling responses, and how caregiver movement may change by continued use of the technology.

In some implementations, characteristics of wireless communication signals (such as Bluetooth signal strength) used by one or more of the wearable devices and the electronic devices (e.g., a wireless device worn or carried by a caregiver) and used to infer and record the distance between them. This distance data provides information necessary to determine periodic physical proximity between the patient and the caregiver and any patterns of the proximity over time (e.g., peak times of patient need or common periods of rest or minimal activity). For example, a patient's wearable device and a caregiver's cellphone that is linked to the wearable device can triangulate their positions to derive measures of caregiver-patient distance.

In addition, the caregiver's mobile app can include a feedback capability enabling the caregiver to mark a patient's polling response as a miscommunication, for example, because the patient's polling response—i.e. patient cue indicated an incorrect health status due to sensor mis-activation, or due to a system usability issue), the system can effectively add quality labels to captured data. For quality improvement, the technology can capture raw biopotential signals and other biopotential information for a period (say one minute) before and after a polling event and the determination , as well as the classification determined by the classifier of micro-motion or muscle activation. Combining this biopotential information with caregiver proximity data (as an indicator of whether the classification was accurate, based on patient intent) would enable optimization of the technology.

### Other Applications

The technology has a wide variety of applications to helped constrained people who are not patients. For example, in many commercial and industrial contexts, workers and other people find themselves in constrained environments in which conventional communication is not possible, safe, sensible, or appropriate. In any such environment or context, the ability of such a worker or other person to communicate without speaking or engaging in typical gesturing can be useful.

For example, in space and other scenarios, stepping through a checklist of activities to confirm that they have been performed may not be possible in the usual way, and can be achieved using the technology. Workers in mines, bomb removal experts, first responders, and other people in dangerous situations or emergency situations also can find the technology useful. Training of remote students can be done effectively by tracking and observing activities represented by biopotential signals and without requiring the student to speak or gesture in typical ways. Other applications include in-fuselage aircraft assembly, deep-mine maintenance and exploration, and mission and training facilitation for soldiers.

Other implementations are also within the scope of the following claims.

1. A method comprising
receiving an inbound message to be presented to a person wearing a wearable device,
presenting the inbound message to the person as tactile stimulation of the skin of the person at the wearable device, and
monitoring for presence of an outbound message encoded from biopotential signals sensed at the skin of the person after and in connection with the receipt of the inbound message, the biopotential signals resulting from brain signals indicating an intention by the person wearing the wearable device to reply to the inbound message.

2. The method of claim 1 in which the inbound message comprises a status request.

3. The method of claim 2 in which the status request comprises a poll.

4. The method of claim 1 in which the presenting of the inbound message comprises vibrating the skin of the person.

5. The method of claim 1 comprising decoding the inbound message as a corresponding profile of tactile stimulation of skin, and in which the presenting comprises presenting the profile of tactile stimulation.

6. The method of claim 1 in which presence of an outbound message within a predetermined response period after the receipt of the inbound message comprises a reply to the inbound message.

7. The method of claim 1 in which lack of presence of an outbound message within a predetermined response period after the receipt of the inbound message comprises a reply to the inbound message.

8. (canceled)

9. The method of claim 8 comprising encoding the sensed biopotential signals as the outbound message.

10. The method of claim 1 comprising sending the outbound message to another participant.

11. The method of claim 1 in which the biopotential signals are sensed at by the wearable device.

12. The method of claim 1 in which the wearable device is situated at a wrist of the person.

13. The method of claim 1 in which the receiving of the inbound message comprises receiving the inbound message wirelessly from another device.

14. The method of claim 1 comprising receiving a series of inbound messages at the wearable device, the inbound messages comprising polls.

15. A method comprising
sending an inbound message to be presented as tactile stimulation of skin of a person wearing a wearable device, and
monitoring for presence of an outbound message encoded from biopotential signals sensed at the skin of the person after and in connection with the sending of the inbound message, the biopotential signals resulting from brain signals indicating an intention by the person wearing the wearable device to reply to the inbound message.

16. The method of claim 15 in which the inbound message comprises a status request.

17. The method of claim 16 in which the status request comprises a poll.

18. The method of claim 15 comprising interpreting presence of an outbound message within a predetermined response period after the sending of the inbound message as a reply to the inbound message.

19. The method of claim 15 comprising interpreting lack of presence of an outbound message within a predetermined response period after the sending of the inbound message as a reply to the inbound message.

20. The method of claim 15 in which sending the outbound message comprises sending the inbound message wirelessly from another device.

21. The method of claim 15 comprising sending a series of output messages comprising polls.

22. An apparatus comprising
a wearable device comprising
a support configured to hold the wearable device on a body part of a user,
a wireless transmitter,
a wireless receiver,
a tactile element configured to be in contact with skin of a user,
a biopotential sensor configured to be in contact with skin of the user,
storage for executable instructions, and
a processor to execute the instructions to cause
the wireless receiver to receive an inbound message,
the tactile element to convey the inbound message to the user through the skin of the user,
the biopotential sensor to sense biopotential signals at the skin of the user within a predetermined amount of time after the inbound messages conveyed to the user through the skin of the user, the biopotential signals resulting from brain signals indicating an intention by the person wearing the wearable device to reply to the inbound message, and
the transmitter to send an outbound message encoded from the biopotential signals or biopotential information derived from the biopotential signals.
